(19) United States
(12) Patent Application Publication
(10) Pub. No.: US 2002/0059403 A1
(43) Pub. Date: May 16, 2002

(54) SYSTEM FOR COLLECTING, SETTING AND CONTROLLING COMMUNICATION NETWORK OPERATION INFORMATION

(76) Inventor: MINORU FUKUSHIGE, TOKYO (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 09/167,532

(22) Filed: Oct. 7, 1998

(30) Foreign Application Priority Data
Oct. 8, 1997 (JP) 9-274904

(51) Int. Cl. G06F 15/177

(52) U.S. Cl. 709/220

(57) ABSTRACT

A system for collecting, setting and controlling communication network operation information is provided that eliminates the redundancy in setting operation information in a communication network and prevents inconsistencies in setting information between a control server and an address resolution server. A control server and an address resolution server have a SNMP function respectively. When the address resolution server is activated, operation information is collected, set, and controlled according to the SNMP function. The address resolution server sends startup notification. In response the startup notification, the control server sends back the startup notification response. Since the operation information on the address resolution server is not registered into the control server at the startup operation, the control server transmits the operation information readout request to the address resolution server. The address resolution server reads the set operation information out of its own table and then outputs it as an operation information readout response. The control server creates an operation information table on the address resolution server and then sends further necessary information as an operation information setting request to be download to the address resolution server.

### BACKGROUND OF THE INVENTION

The present invention relates to a system for collecting, setting and controlling communication network operation information. Particularly, the present invention relates to a system for collecting, setting and controlling operation information in a communication network which contains plural agents and a manager which controls operation of the agents.

In ATM (Asynchronous Transfer Mode) technique based communication networks, the LAN EMULATION OVER ATM (hereinafter referred as LANE) specified by the ATM forum is listed as one of the existing LAN (Local Area Network) emulating techniques. In operation, such a communication network requires servers including control servers (LECS (Lan Emulation Servers)) that implement various controls to plural components (e.g. address resolution servers) in plural networks. Such servers cooperatively operate the communication network.

The server needs to present operation information regarding an address resolution server being a component in response a request from a client (LEC (Lan Emulation Client) which wants to join in a certain network. Hence, the control server has to previously set and store operation information regarding the address resolution server.

The operation information on the address resolution server also is operation information on the address original resolution server. Hence, the operation of the address resolution server can be started by setting the operation information on the address resolution information previously set to the control server.

However, there is the operational problem in that since the current specifications for each server do not realize interserver communications, the address resolution server itself must set optional operation information.

That is, the following concrete problems will arise.

The first problem is that the same operation information must be respectively set by means of the control server and the address resolution server. This leads to the redundancy in setting as well as errors in setting (e.g. inconsistencies in set information between the control server and the address resolution server).

The second problem is that the network cannot be automatically recovered when the address resolution server recovers from its failure, so that the network operation efficiency is deteriorated.

### SUMMARY OF THE INVENTION

The objective of the present invention is to solve the above-mentioned tasks.

The object of the present invention is to provide a system for collecting, setting and controlling communication network operation information, that eliminates the redundancy in setting operation information as well as inconsistencies of setting information between a control server and an address resolution server.

Another object of the present invention is to provide a for collecting, setting and controlling communication network operation information, that enables a network to be automatically recovered when an address resolution server recovers from its failure, thus removing a decrease in the network operation efficiency.

In order to accomplish the above mentioned objects, the objective of the present invention is achieved by a system for collecting, setting and controlling communication network operation information in a communication network, the communication network including plural agents; and a manager for executing operation control of the plural agents; wherein SNMP (Simple Network Management Protocol) is used as a communication protocol between the manager and each of the agents; each of the plural agents having an operation information table in which operation information on each agent is previously set; the managers each including: table creating means for collecting operation information on an agent according to the SNMP and in response to a startup notification from the agent and then creating an operation information table corresponding to the agent; and transmitting means for transmitting information necessary for network operation except the previously set operation information to the agent according to said SNMP.

In the communication network operation information collecting, setting and controlling system according to the present invention, each of the agents information necessary for a network operation transmitted from the manager is set to the operation information table.

In the communication network operation information collecting, setting and controlling system according to the present invention, the manager comprises operation information setting means for collecting operation information on the agent according to the SNMP in response to a startup notification from the agent and then setting the operation information to the operation information table corresponding to the agent.

In the communication network operation information collecting, setting and controlling system according to the present invention, the manager further includes means for periodically transmitting an operation confirmation request by transmitting a broadcast according to the SNMP. As described above, according to the present invention, the SNMP function is added to various servers which configure and operate a communication network. That is, a SNMP manager function is added to the control server acting as a manager. The SNMP agent function is added to the address resolution server acting as an agent. The control server holds operation information regarding plural address servers in a table format. Thus, the control server collects and sets operation information to each address resolution server, thus enabling, for example, the operation information held on the table in the control server to be downloaded at recovery of the address resolution server.

### BRIEF DESCRIPTION OF THE DRAWINGS

This and other objects, features and advantages of the present invention will become more apparent upon a reading of the following detailed description and drawings, in which:

FIG. 1 is a system block diagram illustrating a control system according to an embodiment of the present invention;

FIG. 2 is a functional block diagram illustrating the control server 1 and the address resolution server shown in FIG. 1;

FIG. 3 is a diagram illustrating a message transfer route according to an embodiment of the present invention;

FIG. 4 is a sequence diagram illustrating an operation of the control system according to the present invention;

FIG. 5 is a sequence diagram illustrating another operation of the control system according to the present invention;

FIG. 6 is a diagram illustrating the operation information table in the control server 1;

FIG. 7 is a diagram illustrating the operation information table in the address resolution server 21; and

FIG. 8 is a sequence diagram further illustrating another operation of the control system according to the present invention.

### DESCRIPTION OF THE EMBODIMENTS

Embodiments of the control system according to the present invention will be described below with reference to the attached drawings.

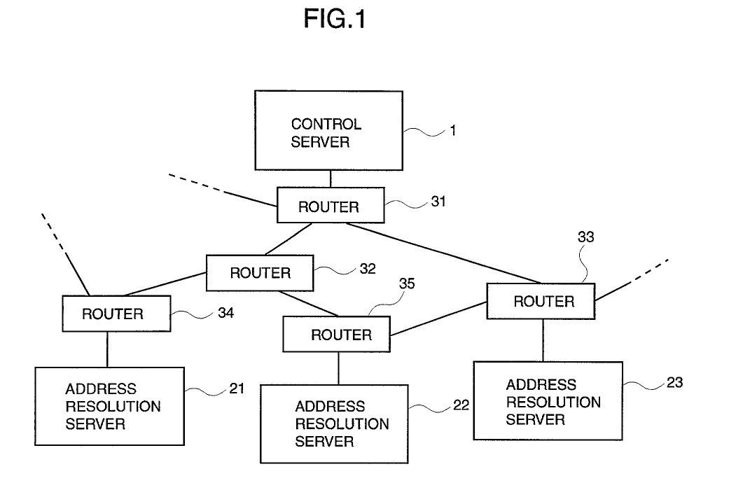

FIG. 1 is a structural diagram illustrating a control system according to an embodiment of the present invention. Referring to FIG. 1, a control server 1 is provided that comprehensively controls components configuring a communication network. The components correspond to plural address resolution servers 21 to 23. Routers 31 to 35 are provided in the communication network. The routers are mutually coupled via dedicated lines. The control server 1 is connected to any one of the routers 31 to 35 via an Ethernet Line while the address solution servers 21 to 23 is connected to any one of the routers 31 to 35 via an Ethernet Link.

Each of the routers 31 to 35 has an IPv4 packet forwarding function and a routing protocol function. The term “IPv4” is an abbreviation for INTERNET PROTOCOL VERSION 4 which is widely used as a protocol for sending data in an internet. The unit of data to be transferred according to the IPv4 protocol is referred to as “IPv4 packet”.

The “forwarding function” is the function of relaying communications between user terminals located at a long distance from each other or the function of transmitting a user packet received from an interface to another optimum interface to send it to the destination address specified by the user packet. The “routing protocol function” is the function of collecting information for realizing the forwarding function by a router according to information exchanged between routers (that is, information for deciding an address that a user data packet with an arbitrary destination address is transmitted), and of editing information used for forwarding. The IP network is configured by mutually connecting plural routers 31 to 35 with the above-mentioned functions.

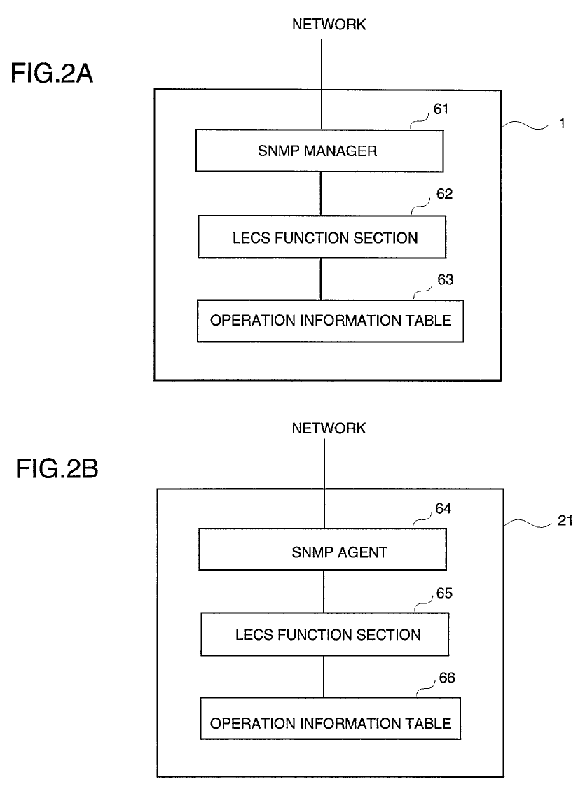

FIG. 2(A) is a functional block diagram of the control server 1. The control server 1 includes a SNMP manager 61, an LECS (LAN EMULATION CONFIGURATION SERVER) function section 62, and an operation information table section 63. The term SNMP is an abbreviation of Simple Network Management Protocol. SNMP is one protocol technique used for controlling and monitoring via a network a device connected to a network typified by an internet. The SNMP function is the function of controlling and monitoring the network equipment using the SNMP.

The SNMP manager 61 has the function of the side which controls and monitors network equipment, that is, of a main function side. The LECS function section 62 has the function of providing user terminals (LEC (LAN EMULATION CLIENT), or an address resolution server in the present embodiment) connected to a network configured with LANE (LAN EMULATION) with various kinds of information for network connection.

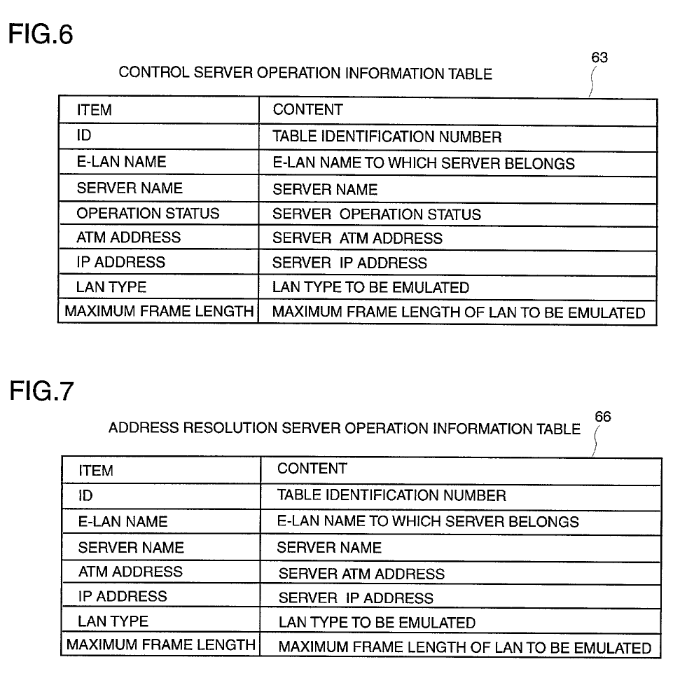

The operation information table section 63 has the function of setting and holding operation information of all address resolution servers 21 to 23 to be controlled. The table format is shown in FIG. 6.

FIG. 2(B) is a functional block diagram of the address resolution server 21. The remaining address resolution servers 22 and 23 have the same configuration as that of the server 21. The address resolution server 21 consists of a SNMP agent 64, an LES function section 65, and an operation information table section 66.

The SNMP agent 64 is prepared to the SNMP manger 61 in the control server 1 and has the function of the side to be controlled and monitored, that is, of a follower function. The LES (LAN EMULATION SERVER) function section 65 has the function of an address resolution server. The address resolution server is the server function for resolving a physical layer address to a link layer address in response to a request from a user terminal when a data packet transmitting terminal knows the link layer address (in this case, a MAC address) of the destination terminal of a data packet, but does not know the physical layer address (a layer lower than the link address, that is, an ATM address in this case).

This function is the server function used in a LAN emulation (LANE) specified by the ATM forum of the standardization organization. The LAN emulation is a network technique of enabling a protocol used on the so-called LAN such as Ethernet or FDDI to be used in an ATM network.

The operation information table 66 is a table for setting and holding various kinds of operation information on the address resolution server 21. Since the control server 1 is connected to plural address resolution servers 21 to 23 via the routers 31 to 35, one SNMP community is configured with the SNMP manager 61 in the control server 1 and the SNMP agent 64 of each of plural address resolution servers 21 to 23.

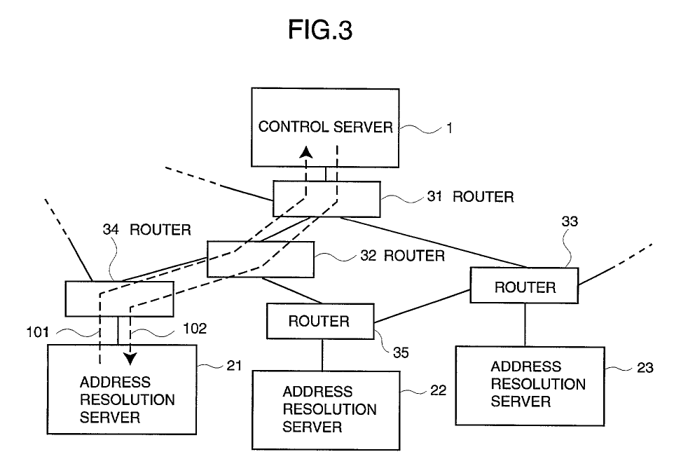

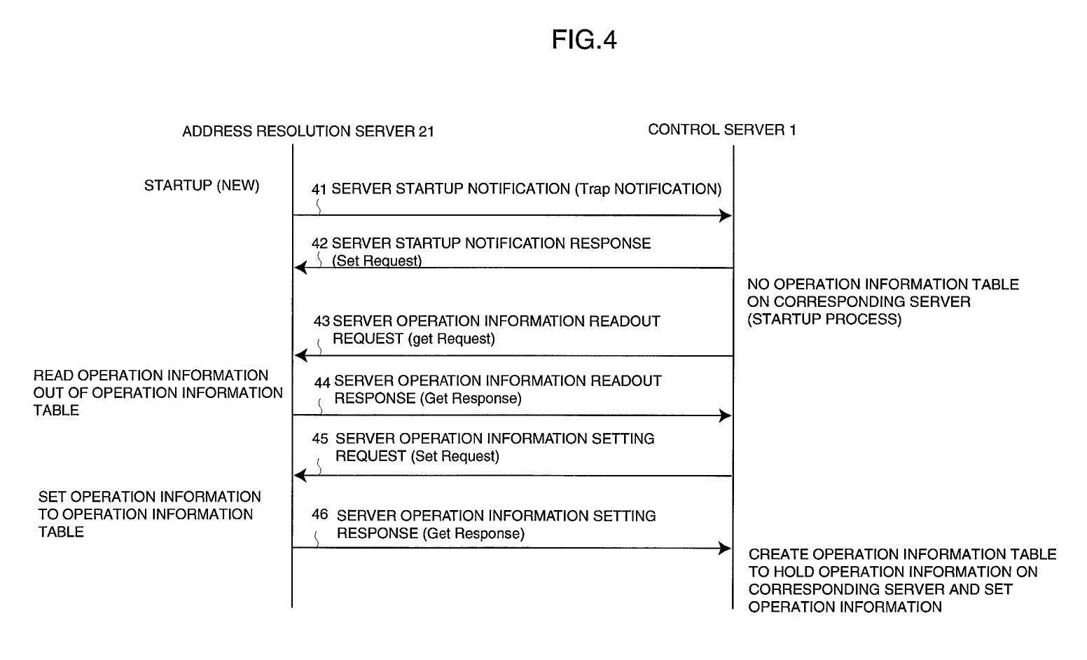

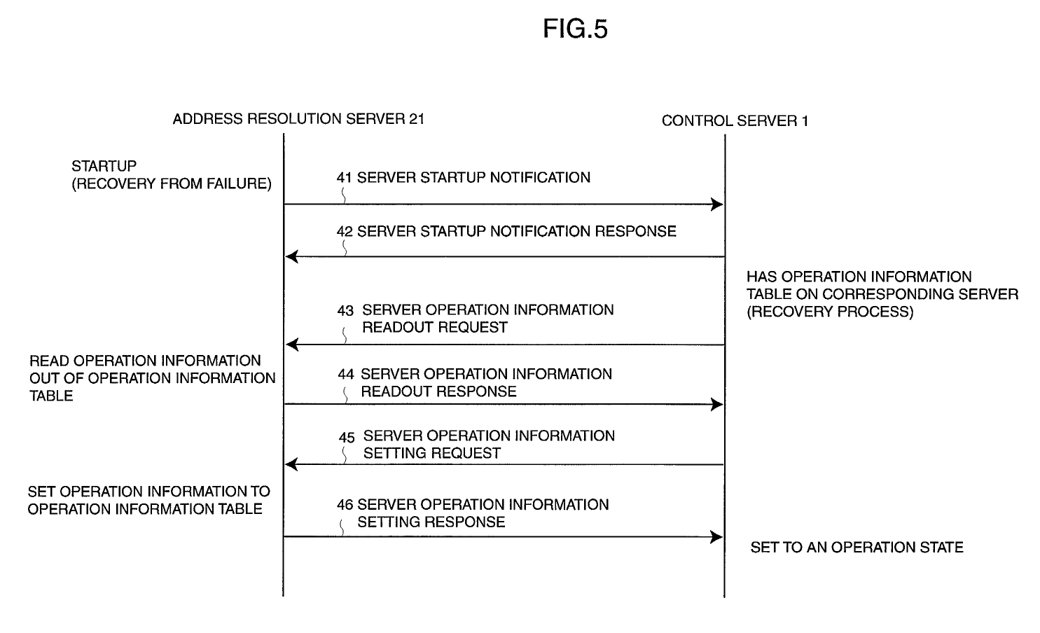

FIG. 3 shows the case where messages 101 and 102 are exchanged as the SNMP protocol message. The exchange operation is performed using IPv4 packets. The detail is described with reference to FIGS. 4 and 5.

With reference to FIG. 4, the process procedure of the case where the address resolution server 21 is newly activated will be described. After a fixed elapsed time period from the startup, the address resolution server 21 notifies the control server 1 that the server startup notification 41 (Trap notification of SNMP) has been transmitted and that the address resolution server 21 is activated. In contrast, in response to the server startup notification 41, the control server 1 returns the server startup notification response 42 to the address resolution server (using SNMP Set Request), thus notifying the address resolution server 21 that the server startup notification 41 has been received.

Next, the control server 1 retrieves the operation information table section 63 held by itself and verifies the presence or absence of the table regarding itself. In this case, as shown in FIG. 6, identification information ID is provided in each table. One ID corresponds to one address resolution server under control.

Since the control server 1 does not hold operation information regarding the address resolution server 21 in the initial state, no table exists when the address resolution server has notified of the startup through a new startup process. As a result, the startup process begins. In this startup process, the control server 1 transmits the server operation information read-out request 43 (using SNMP Get Request) because the address resolution server 21 reads operation information (such as E-LAN names, server names, ATM addresses, IP addresses) out of the table 66.

In contrast, the address resolution server 21 responds by setting read-out information preset in the operation information table 66 to the server operation information read-out response 44 (using SNMP Get Response). Next, in order to set operation information (LAN TYPE, the maximum frame length) necessary for operation as LANE to the address resolution server 21, the control server 1 transmits information set to the server operation information set request 45 (using SNMP Set Request). The address resolution server 21 sets respective pieces of set information to the operation information table 66 and then returns the server operation information set response 46 (using SNMP Get Response).

Upon completion of the above-mentioned message process, the control server 1 newly creates an operation information table 63 regarding the address resolution server 21 and then holds various kinds of operation information read out. In this case, “in operation” is set to the operation status in the operation information table 63.

The case where the address resolution server 21 recovers from its failure and restarts up will be described here with reference to FIG. 5. Likewise the startup operation, the address resolution server 21 transmits the server startup notification 41 to the control server 1 after a failure recovery and then notifies the control server 1 that the address resolution server 21 has been recovered from failure. In contrast, the control server 1 sends the server startup notification response 42 to the address resolution server 21 and then notifies the address resolution server 21 that the server startup notification has been received.

Next, the control server 1 retrieves the operation information table section 63 and verifies the presence or absence of the table regarding the server 21. In this case, since the server 21 is restarted up for recovery, the information regarding the address resolution server 21 has been already set to the operation information table section 63. Thus, the recovery process is initiated.

In this recovery process, the control server 1 transmits the server operation information read-out request 43 to read out operation information (ATM address) held in the address resolution server 21. The address resolution server 21 responds by reading information of interest out of the operation information table 66 and setting it to the server operation information read-out response 44.

Next, in order to download operation information regarding the address resolution server 21 held in the operation information table section 63, the control server 1 sets and transmits information to the server operation information setting request 45 for setting various kinds of operation information (E-LAN name, server name, LAN TYPE, and maximum frame length). The address resolution server 21 sets various kinds of set information to the operation information table 66 and returns the server operation information setting response 46.

Upon completion the above-mentioned message process, the control server 1 sets the operation status of the operation information table regarding the address resolution server 21 to “in operation”.

“E-LAN name” in the operation information table is represented in a character chain of a suitable length, for example, in “ELAM#1”. “ETHERNET/IEEE802.3” or “IEEE802.5”, for example, is listed as “LAN TYPE” and belongs to the type of LAN that can expand on the ATM network using the LANE technique. Moreover, “maximum frame length” is the maximum data length which can be transferred by using the LANE technique. For example, the maximum data length is 1516 bytes in the case of “ETHERNET/IEEE802.3”.

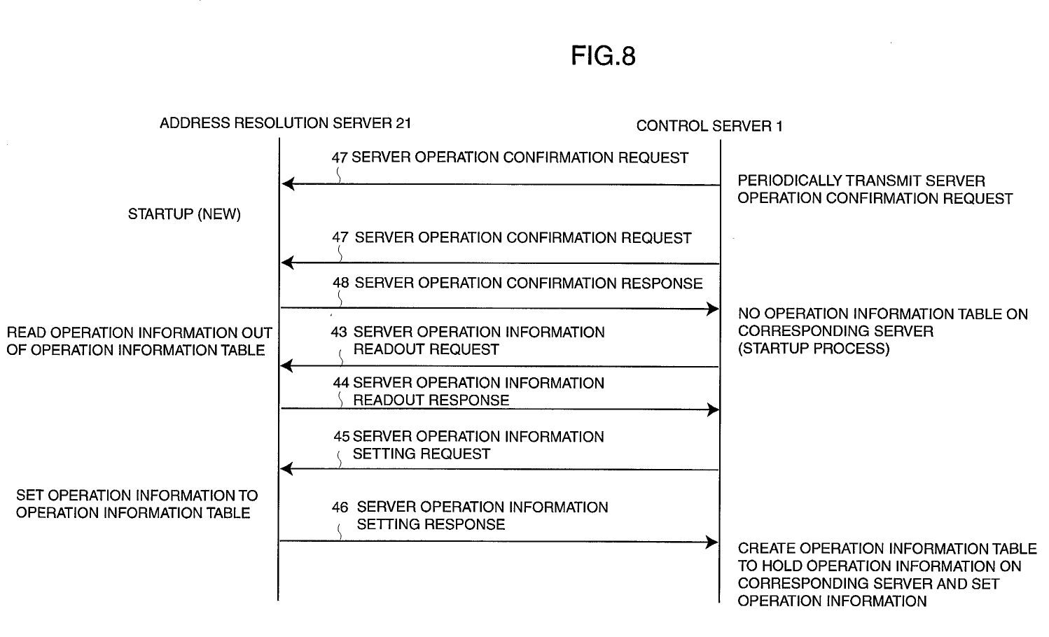

FIG. 8 is a sequence diagram illustrating the operation of the control system according to another embodiment of the present invention. In the above-mentioned embodiment, when the address resolution server starts up, the address resolution server itself transmits the server startup notification 41 to the control server 1, so that the startup process is performed. However, in this embodiment, the server startup notification 41 is not used at the startup. Instead, the control server 1 transmits the server operation confirmation request 47 (broadcast transfer) to all address resolution servers controlled by itself in a fixed period.

If the address resolution server is not started up, there is no server operation confirmation response 48 to the server operation confirmation request 47, so that the control server 1 does not act. If an arbitrary address resolution server is started up, the server operation confirmation response 48 is transmitted, so that the control server 1 acts to the response. The following operation proceeds according to the sequence shown in FIG. 4.

In the above-mentioned operation, when a given resolution server in operation is damaged due to a cause, the server operation confirmation response 48 does not return. Hence, the control server 1 can recognizes that the address resolution server is in an operation halt state.

As described above, according to the present invention, the operation information regarding an address resolution server to be previously set is collected and set to the control server under remote control via the network. This enables the server to be in an operable state without performing an extra setting operation to the server at a startup time and a failure recovery time of the address resolution server. As a result, since the operation of respectively setting the control server and the address resolution server is eliminated, a network failure due to erroneous setting operation can be effectively prevented. The entire disclosure of Japanese Patent Application No. 9-274904 filed on Oct. 8, 1997 including specification, claims, drawing and summary are incorporated herein by reference in its entirety.

What is claimed is:

1. A system for collecting, setting and controlling communication network operation information in a communication network, said communication network including:
plural agents; and
a manager for executing operation control of said plural agents;
wherein SNMP (Simple Network Management Protocol) is used as a communication protocol between said manager and each of said agents;
each of said plural agents having an operation information table in which operation information on each agent is previously set;
said managers each including:
table creating means for collecting operation information on an agent according to said SNMP and in response to a startup notification from said agent and then creating an operation information table corresponding to said agent; and
transmitting means for transmitting information necessary for network operation except said previously set operation information to said agent according to said SNMP.

2. The communication network operation information collecting, setting and controlling system defined in claim 1, wherein each of said agents sets information necessary for a network operation transmitted from said manager is set to said operation information table.

3. The communication network operation information collecting, setting and controlling system defined in claim 1, wherein said manager comprises operation information setting means for collecting operation information on said agent according to said SNMP in response to a startup notification from said agent and then setting said operation information to said operation information table corresponding to said agent.

4. The communication network operation information collecting, setting and controlling system defined in claim 2, wherein said manager comprises operation information setting means for collecting operation information on said agent according to said SNMP in response to a startup notification from said agent and then setting said operation information to said operation information table corresponding to said agent.

5. The communication network operation information collecting, setting and controlling system defined in claim 3, wherein said operation information setting means sets “in operation” in an operation status item of said operation information table.

6. The communication network operation information collecting, setting and controlling system defined in claim 4, wherein said operation information setting means sets “in operation” in an operation status item of said operation information table.

7. The communication network operation information collecting, setting and controlling system defined in claim 1, wherein said manager further includes means for periodically transmitting an operation confirmation request by transmitting a broadcast according to said SNMP.

8. The communication network operation information collecting, setting and controlling system defined in claim 2, wherein said manager further includes means for periodically transmitting an operation confirmation request by transmitting a broadcast according to said SNMP.

9. The communication network operation information collecting, setting and controlling system defined in claim 3, wherein said manager further includes means for periodically transmitting an operation confirmation request by transmitting a broadcast according to said SNMP.

10. The communication network operation information collecting, setting and controlling system defined in claim 4, wherein said manager further includes means for periodically transmitting an operation confirmation request by transmitting a broadcast according to said SNMP.

11. The communication network operation information collecting, setting and controlling system defined in claim 5, wherein said manager further includes means for periodically transmitting an operation confirmation request by transmitting a broadcast according to said SNMP.

12. The communication network operation information collecting, setting and controlling system defined in claim 6, wherein said manager further includes means for periodically transmitting an operation confirmation request by transmitting a broadcast according to said SNMP.

13. The communication network operation information collecting, setting and controlling system defined in any one of claims 1 to 12, wherein each of said plural agents is an address resolution server; and wherein said manager is a control server for comprehensively controlling said address resolution server.
